(19) United States
(12) Patent Application Publication
(10) Pub. No.: US 2014/0146413 A1
(43) Pub. Date: May 29, 2014

(54) Systems and Methods for Enhanced Servo Data Processing

(71) Applicant: LSI CORPORATION, Milpitas, CA (US)

(72) Inventors: Haitao Xia, San Jose, CA (US); Xun Zhang, Westford, MA (US); Dahua Qin, Allentown, PA (US); Jiangzhong Huang, Storrs, CT (US)

(73) Assignee: LSI Corporation, Milpitas, CA (US)

(21) Appl. No.: 13/685,990

(22) Filed: Nov. 27, 2012

(51) Int. Cl. G11B 20/12; H04B 1/16

(52) U.S. Cl. CPC G11B 20/1217; H04B 1/16
USPC 360/48; 375/340

(57) ABSTRACT

Systems and method relating generally to detecting information, and more particularly without limitation to systems and methods for synchronizing to a data stream.

### FIELD OF THE INVENTION

The present invention relates generally to detecting information, and more particularly without limitation to systems and methods for synchronizing to a data stream.

### BACKGROUND

Typical data processing involves receiving a data stream and processing the data stream to recover the originally provided data. In such systems, a data clock may be recovered from the received data stream, and used to process the received data. This clock recovery often relies on a phase lock loop circuit driven by a phase to phase sampling error on a known pattern. After locking to the data stream, various data derived from the stream is accessed and used to perform data recovery. In some cases, the data stream includes information received at different data rates. Such different data rates often require complex processing circuitry that is in some cases inaccurate.

Hence, for at least the aforementioned reasons, there exists a need in the art for advanced systems and methods for data processing.

### SUMMARY

The present invention relates generally to detecting information, and more particularly without limitation to systems and methods for synchronizing to a data stream.

Some embodiments of the present invention provide data processing systems that include a multi-format data processing circuit operable to process a data set including a first codeword encoded using a first encoding format and a second codeword encoded using a second encoding format. The multi-format data processing circuit includes a data detection circuit operable to apply a symbol based data detection algorithm to symbols derived from the data set, where each symbol represents less than the number of bits in the first codeword and the number of bits in the second codeword.

This summary provides only a general outline of some embodiments of the invention. The phrases “in one embodiment,” “according to one embodiment,” “in various embodiments”, “in one or more embodiments”, “in particular embodiments” and the like generally mean the particular feature, structure, or characteristic following the phrase is included in at least one embodiment of the present invention, and may be included in more than one embodiment of the present invention. Importantly, such phases do not necessarily refer to the same embodiment. Many other embodiments of the invention will become more fully apparent from the following detailed description, the appended claims and the accompanying drawings.

### BRIEF DESCRIPTION OF THE FIGURES

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram of a known magnetic storage medium and sector data scheme;

FIG. 2 shows a storage device including a multi-format servo data detector circuit in accordance with different embodiments of the present invention;

FIG. 3 depicts a communication system including a multi-format servo data detector circuit in accordance with different embodiments of the present invention;

FIG. 4 shows a data processing circuit including a multi-format servo data detector circuit in accordance with various embodiments of the present invention;

FIG. 5 shows a trellis diagram representing operation of a four state, symbol based data detector circuit that may be used in place of the multi-format servo data detector circuit of FIG. 4;

FIG. 6 is a flow diagram showing a method in accordance with some embodiments of the present invention for processing servo data using a four state, symbol based data detection circuit;

FIGS. 7a-7c shows a pruned trellis diagram representing operation of a four state, symbol based data detector circuit that may be used in place of the multi-format servo data detector circuit of FIG. 4; and

FIG. 8 is a flow diagram showing a method in accordance with some embodiments of the present invention for processing servo data using a selectively pruned four state, symbol based data detection.

### DETAILED DESCRIPTION OF SOME EMBODIMENTS

The present invention relates generally to detecting information, and more particularly without limitation to systems and methods for synchronizing to a data stream.

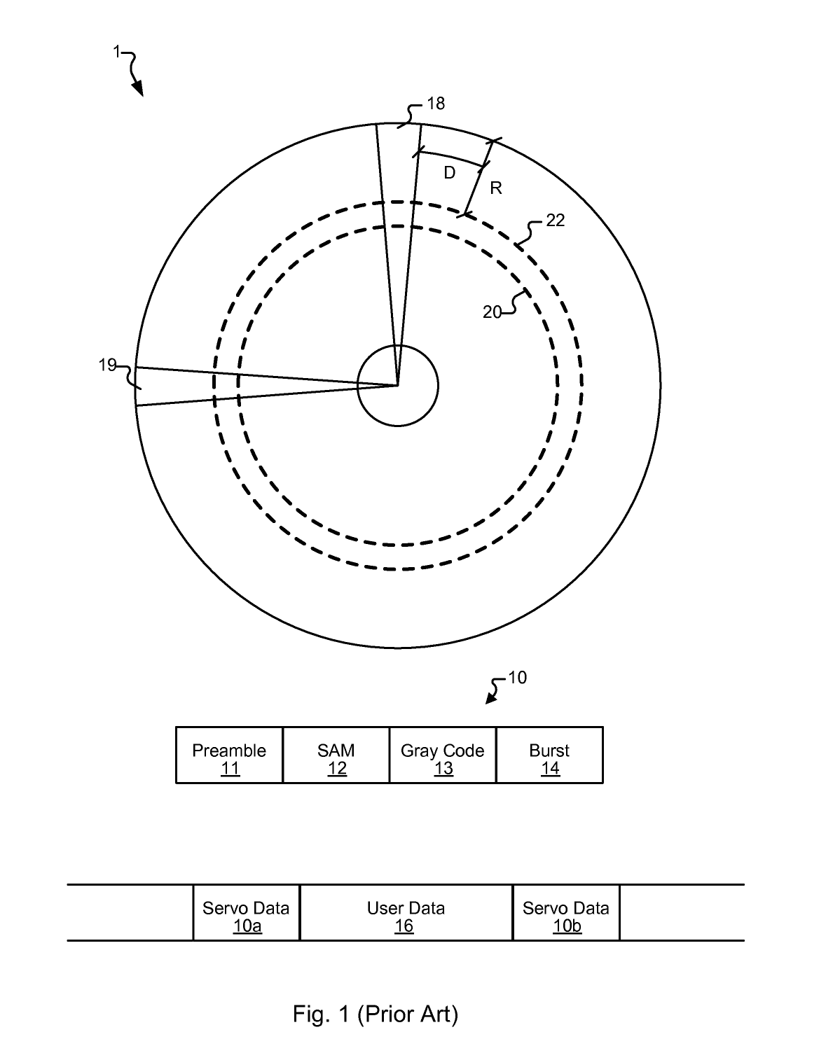

Turning to FIG. 1, a storage medium 1 is shown with two exemplary tracks 20, 22 indicated as dashed lines. The tracks are segregated by servo data written within wedges 19, 18. These wedges include servo data 10 that are used for control and synchronization of a read/write head assembly over a desired location on storage medium 1. In particular, this servo data generally includes a preamble pattern 11 followed by a sector address mark 12 (SAM). Sector address mark 12 may include wedge identification information followed by the SAM. Sector address mark 12 is followed by a Gray code 13, and Gray code 13 is followed by burst information 14. Gray code 13 may include track identification information. It should be noted that while two tracks and two wedges are shown, hundreds of each would typically be included on a given storage medium. Further, it should be noted that a servo data set may have two or more fields of burst information. Yet further, it should be noted that different information may be included in the servo fields such as, for example, repeatable run-out information that may appear after burst information 14. Between the servo data bit patterns 10a and 10b, a user data region 16 is provided.

In operation, storage medium 1 is rotated in relation to a sensor that senses information from the storage medium. In a read operation, the sensor would sense servo data from wedge 19 (i.e., during a servo data period) followed by user data from a user data region between wedge 19 and wedge 18 (i.e., during a user data period) and then servo data from wedge 18. In a write operation, the sensor would sense servo data from wedge 19 then write data to the user data region between wedge 19 and wedge 18. Then, the sensor would be switched to sense a remaining portion of the user data region followed by the servo data from wedge 18.

Various embodiments of the present invention provide servo data processing systems capable of processing multi-rate Gray code data. Such multi-rate Gray code data may be referred to herein as either multi-rate or multi-format. As one example, the multi-rate Gray code data may include a first number of elements represented by high rate encoded codewords, and a second number of elements represented by low rate encoded codewords. In one particular embodiment of the present invention, low rate codewords are encoded such that a ‘111000’ represents a bit value of zero, and a ‘000111’ represents a bit value of one; and high rate codewords are encoded such that a ‘1100’ represents a bit value of zero, and a ‘0011’ represents a bit value of one.

The servo data processing systems include a multi-format servo data detector circuit operable to detect both the high rate codewords and the low rate codewords. In some embodiments of the present invention, the multi-format servo data detector circuit is a four state, symbol based data detector circuit. In some particular embodiments of the present invention, the multi-format servo data detector circuit is a selectively pruned four state, symbol based data detector circuit.

Some embodiments of the present invention provide data processing systems that include a multi-format data processing circuit operable to process a data set including a first codeword encoded using a first encoding format and a second codeword encoded using a second encoding format. The multi-format data processing circuit includes a data detection circuit operable to apply a symbol based data detection algorithm to symbols derived from the data set, where each symbol represents less than the number of bits in the first codeword and the number of bits in the second codeword. In some instances of the aforementioned embodiments, the first codeword is a low rate codeword, and wherein the second codeword is a high rate codeword. In various embodiments of the present invention, each symbol is a two bit symbol, the first codeword is six bits, the second codeword is four bits, the first encoding format represents one bit value with six data bits, and the second encoding format represents one bit value with four bits. In one particular instance of the aforementioned embodiments, the first encoding format represents a ‘1’ as ‘000111’, and a ‘0’ as ‘11100’; and the second encoding format represents a ‘1’ as ‘0011’, and a ‘0’ as ‘1100’. In some instances of the aforementioned embodiments, the system is implemented as an integrated circuit.

In some instances of the aforementioned embodiments, the symbol based data detection algorithm is implemented to limit possible transitions to those expected when processing symbols derived from the combination of the first encoding format and the second encoding format. In other instances of the aforementioned embodiments, the symbol based data detection algorithm is selectively pruned to limit possible transitions to those expected when processing symbols derived from the combination of the first encoding format and the second encoding format. Such selectively pruning the symbol based data detection algorithm includes: limiting possible transitions based at least in part upon whether a currently processing symbol corresponds to a transition between a boundary of two different codewords; and/or limiting possible transitions based at least in part upon whether a currently processing symbol corresponds to a transition between two symbols within the same codeword. In some cases, such selectively pruning the symbol based data detection algorithm further includes limiting possible transitions based at least in part upon whether a currently processing symbol is derived from the first codeword or the second codeword.

In various instances of the aforementioned embodiments where the data detection circuit is a first data detection circuit and the data set is servo data derived from a storage medium, the data processing system further includes: a second data detection circuit operable to apply a data detection algorithm to a user data set derived from the same source as the servo data set to yield a detected output; and a data decoder circuit operable to apply a data decoding algorithm to a decoder input derived from the detected output to yield a decoded output. In some cases, the data decoder circuit is a low density parity check decoder circuit. In one or more cases, the second data detection circuit is a maximum a posteriori data detector circuit. In another case, the second data detection circuit is a Viterbi algorithm data detector circuit.

Other embodiments of the present invention provide methods for data processing that include: receiving a data input including at least a first codeword encoded using a first encoding format and a second codeword encoded using a second encoding format, where a length of the first codeword is different from a length of the second codeword; and applying a symbol based data detection algorithm to symbols derived from the data set, where each symbol represents less than the number of bits in the first codeword and the number of bits in the second codeword. In some instances of the aforementioned embodiments, each symbol is a two bit symbol, where: the first codeword is six bits, the second codeword is four bits, the first encoding format represents one bit value with six data bits, and the second encoding format represents one bit value with four bits. In one or more instances of the aforementioned embodiments, the symbol based data detection algorithm limits possible transitions to those expected when processing symbols derived from the combination of the first encoding format and the second encoding format. In various embodiments of the present invention, the symbol based data detection algorithm is selectively pruned to limit possible transitions to those expected when processing symbols derived from the combination of the first encoding format and the second encoding format. In some such instances, selectively pruning the symbol based data detection algorithm includes limiting possible transitions based at least in part upon whether a currently processing symbol corresponds to a transition between a boundary of two different codewords. In other cases, the selectively pruning the symbol based data detection algorithm includes limiting possible transitions based at least in part upon whether a currently processing symbol corresponds to a transition between two symbols within the same codeword. In one particular case, selectively pruning the symbol based data detection algorithm further includes limiting possible transitions based at least in part upon whether a currently processing symbol is derived from the first codeword or the second codeword.

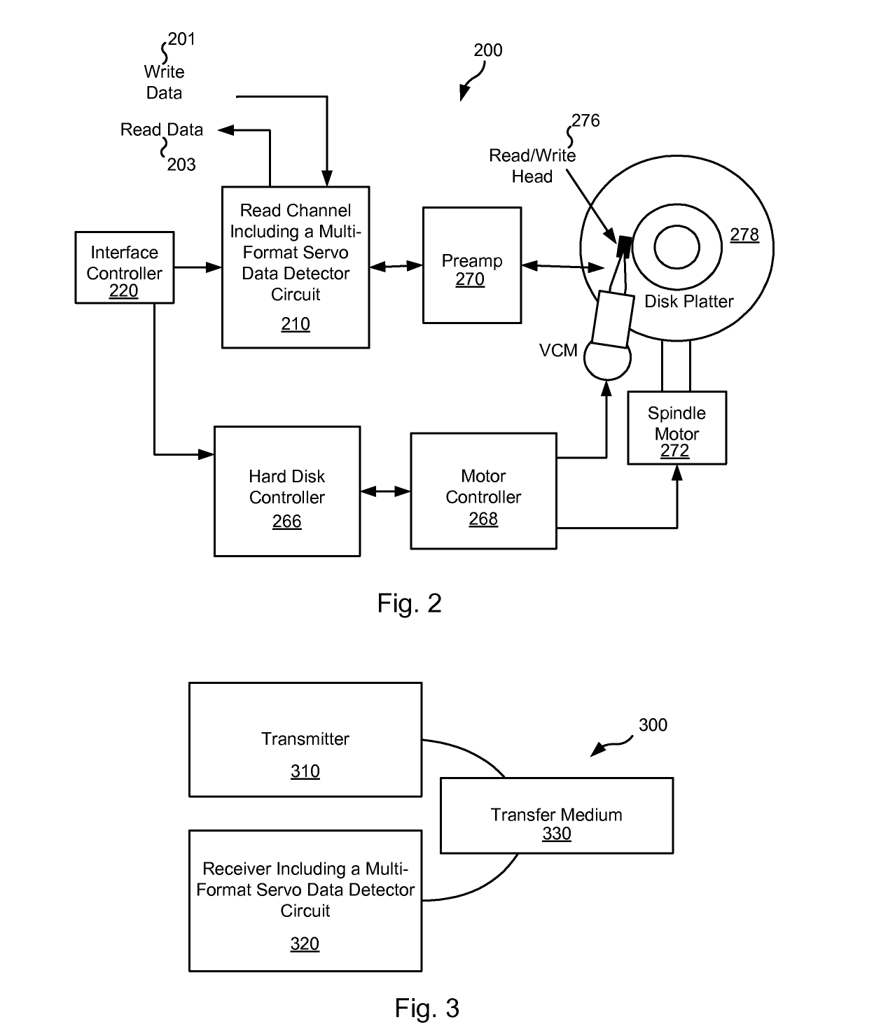

Turning to FIG. 2, a storage system 200 including a read channel circuit 210 having a multi-format servo data detector circuit is shown in accordance with various embodiments of the present invention. Storage system 200 may be, for example, a hard disk drive. Storage system 200 also includes a preamplifier 270, an interface controller 220, a hard disk controller 266, a motor controller 268, a spindle motor 272, a disk platter 278, and a read/write head 276. Interface controller 220 controls addressing and timing of data to/from disk platter 278, and interacts with a host controller 290. The data on disk platter 278 consists of groups of magnetic signals that may be detected by read/write head assembly 276 when the assembly is properly positioned over disk platter 278. In one embodiment, disk platter 278 includes magnetic signals recorded in accordance with either a longitudinal or a perpendicular recording scheme.

In a typical read operation, read/write head assembly 276 is accurately positioned by motor controller 268 over a desired data track on disk platter 278. Motor controller 268 both positions read/write head assembly 276 in relation to disk platter 278 and drives spindle motor 272 by moving read/write head assembly to the proper data track on disk platter 278 under the direction of hard disk controller 266. Spindle motor 272 spins disk platter 278 at a determined spin rate (RPMs). Once read/write head assembly 276 is positioned adjacent the proper data track, magnetic signals representing data on disk platter 278 are sensed by read/write head assembly 276 as disk platter 278 is rotated by spindle motor 272. The sensed magnetic signals are provided as a continuous, minute analog signal representative of the magnetic data on disk platter 278. This minute analog signal is transferred from read/write head assembly 276 to read channel circuit 210 via preamplifier 270. Preamplifier 270 is operable to amplify the minute analog signals accessed from disk platter 278. In turn, read channel circuit 210 decodes and digitizes the received analog signal to recreate the information originally written to disk platter 278. This data is provided as read data 203 to a receiving circuit. A write operation is substantially the opposite of the preceding read operation with write data 201 being provided to read channel circuit 210. This data is then encoded and written to disk platter 278.

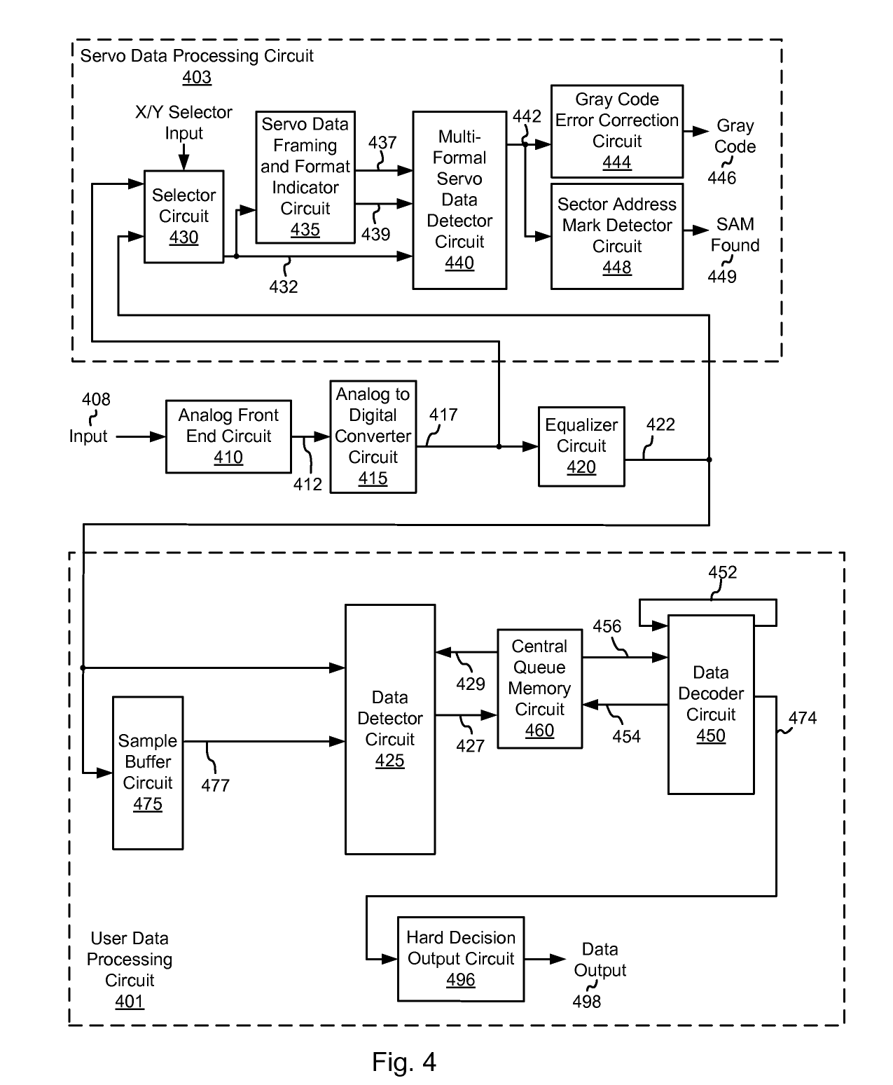

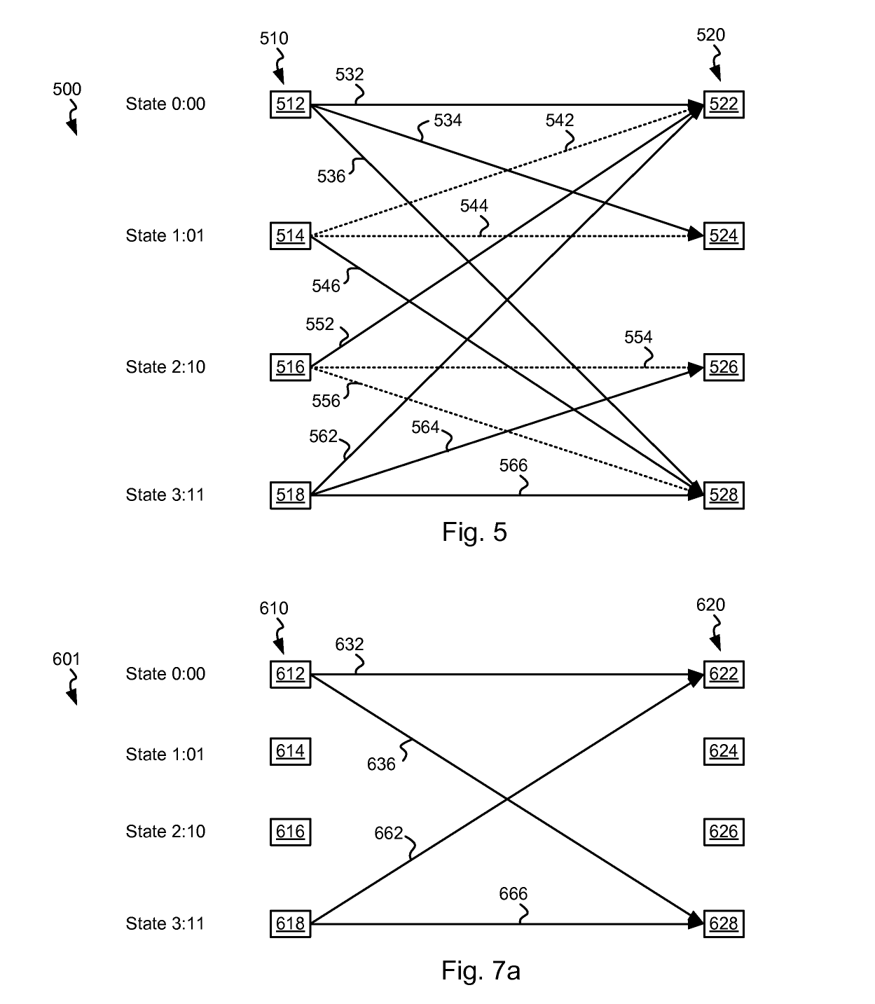

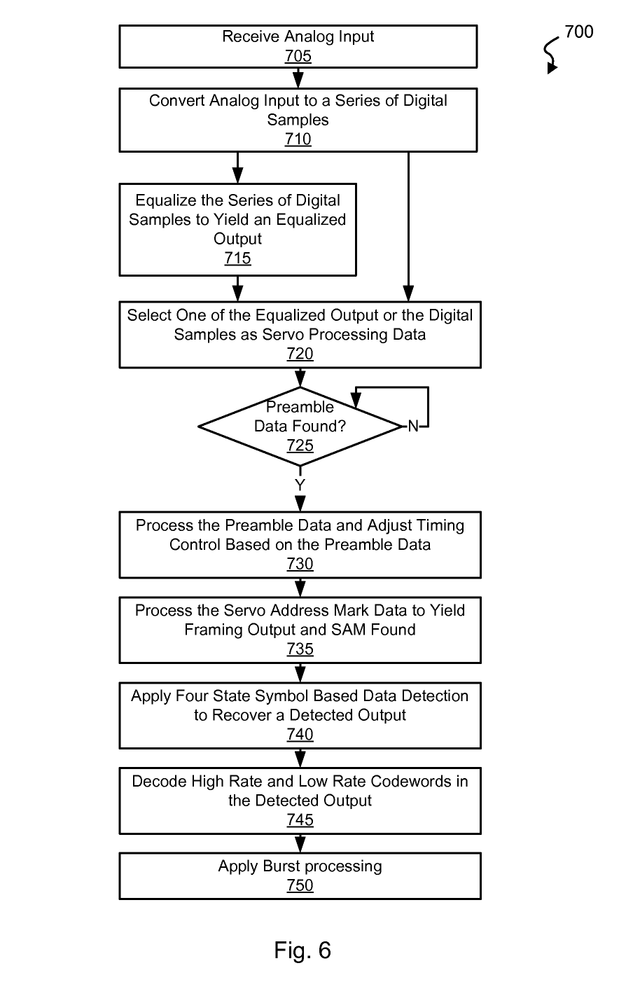

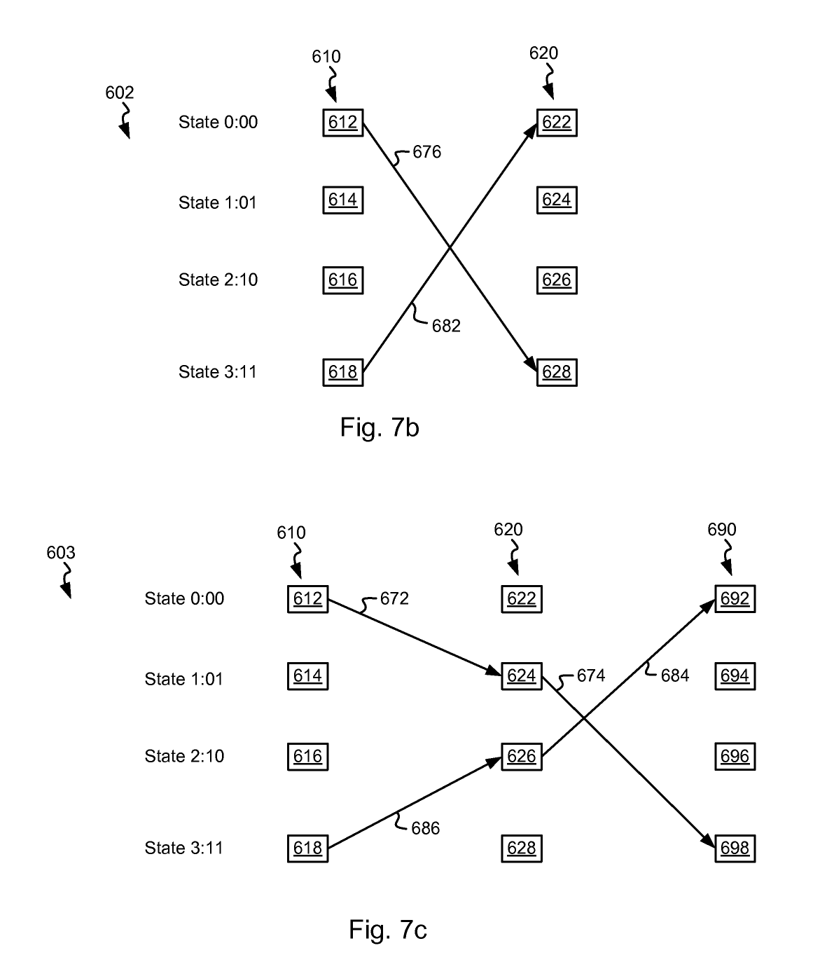

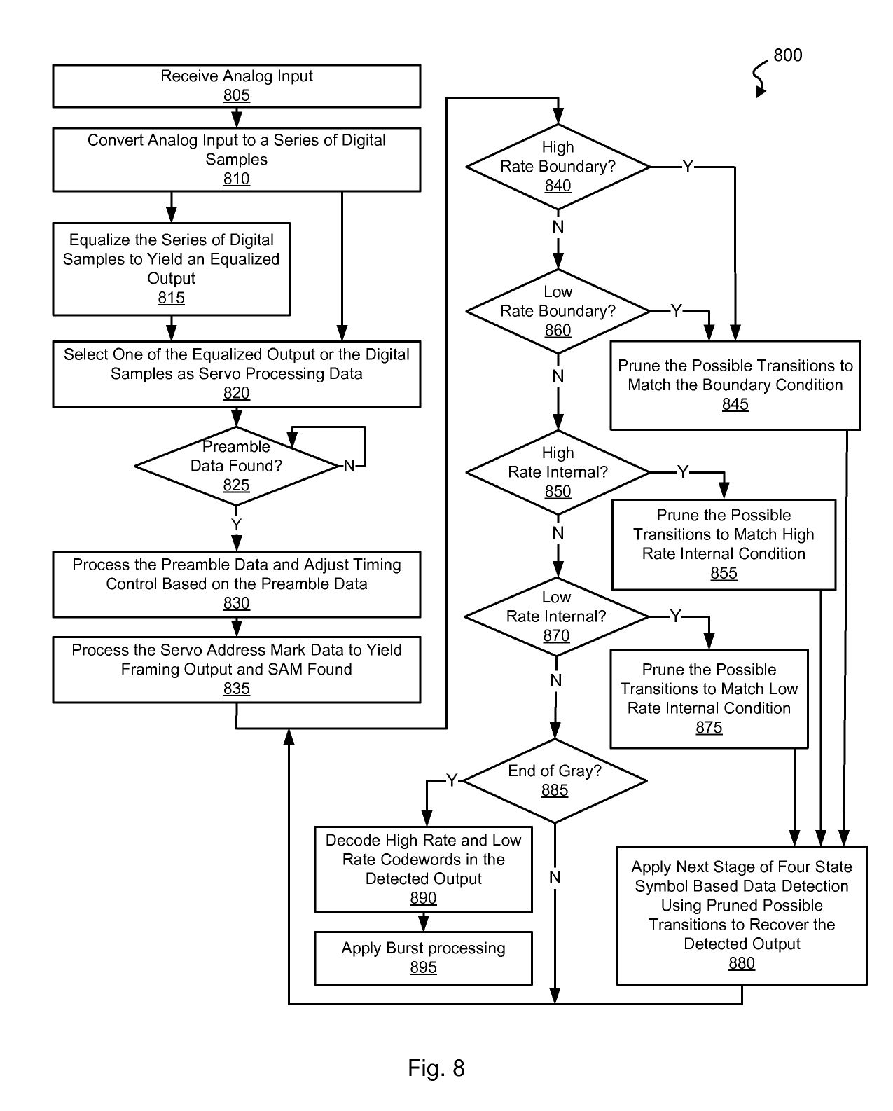

As part of accessing data from disk platter 278 during a read operation, servo data is accessed that includes multi-format data. The multi-format data is processed using a multi-format servo data detector circuit capable of processing the different formats to recover information relevant to processing data access from disk platter 278. In some cases, the read channel circuit may include circuitry similar to that discussed in relation to FIG. 4, FIG. 5 and/or FIGS. 7a-7c; and/or may operate similar to the methods discussed below in relation to FIG. 6 and/or FIG. 8.

It should be noted that storage system 200 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such as storage system 200, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

A data decoder circuit used in relation to read channel circuit 210 may be, but is not limited to, a low density parity check (LDPC) decoder circuit as are known in the art. Such low density parity check technology is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

In addition, it should be noted that storage system 200 may be modified to include solid state memory that is used to store data in addition to the storage offered by disk platter 278. This solid state memory may be used in parallel to disk platter 278 to provide additional storage. In such a case, the solid state memory receives and provides information directly to read channel circuit 210. Alternatively, the solid state memory may be used as a cache where it offers faster access time than that offered by disk platted 278. In such a case, the solid state memory may be disposed between interface controller 220 and read channel circuit 210 where it operates as a pass through to disk platter 278 when requested data is not available in the solid state memory or when the solid state memory does not have sufficient storage to hold a newly written data set. Based upon the disclosure provided herein, one of ordinary skill in the art will recognize a variety of storage systems including both disk platter 278 and a solid state memory.

Turning to FIG. 3, a data transmission system 300 including a receiver 320 having a multi-format servo data detector circuit is shown in accordance with various embodiments of the present invention. Data transmission system 300 includes a transmitter 310 that is operable to transmit encoded information via a transfer medium 330 as is known in the art. The encoded data is received from transfer medium 330 by a receiver 320. Receiver 320 processes the received input to yield the originally transmitted data.

As part of receiving data from transfer medium 330, synchronization data included in the transmitted data includes multi-format data. The multi-format data is processed using a multi-format synchronization data detector circuit capable of processing the different formats to recover information relevant to processing data received from transfer medium 330. In some cases, the multi-format synchronization data detector circuit may include circuitry similar to that discussed in relation to FIG. 4, FIG. 5 and/or FIGS. 7a-7c; and/or may operate similar to the methods discussed below in relation to FIG. 6 and/or FIG. 8.

FIG. 4 shows a data processing circuit 400 including a multi-format servo data detector circuit 440 in accordance with some embodiments of the present invention. Data processing circuit 400 includes an analog front end circuit 410 that receives an analog signal 408. Analog front end circuit 410 processes analog signal 408 and provides a processed analog signal 412 to an analog to digital converter circuit 415. Analog front end circuit 410 may include, but is not limited to, an analog filter and an amplifier circuit as are known in the art. Based upon the disclosure provided herein, one of ordinary skill in the art will recognize a variety of circuitry that may be included as part of analog front end circuit 410. In some cases, analog input signal 408 is derived from a read/write head assembly (not shown) that is disposed in relation to a storage medium (not shown). In other cases, analog input signal 408 is derived from a receiver circuit (not shown) that is operable to receive a signal from a transmission medium (not shown). The transmission medium may be wired or wireless. Based upon the disclosure provided herein, one of ordinary skill in the art will recognize a variety of source from which analog input signal 408 may be derived.

Analog to digital converter circuit 415 converts processed analog signal 412 into a corresponding series of digital samples 417. Analog to digital converter circuit 415 may be any circuit known in the art that is capable of producing digital samples corresponding to an analog input signal. Based upon the disclosure provided herein, one of ordinary skill in the art will recognize a variety of analog to digital converter circuits that may be used in relation to different embodiments of the present invention. Digital samples 417 are provided to an equalizer circuit 420. Equalizer circuit 420 applies an equalization algorithm to digital samples 417 to yield an equalized output 422. In some embodiments of the present invention, equalizer circuit 420 is a digital finite impulse response filter circuit as are known in the art. It may be possible that equalized output 422 may be received directly from a storage device in, for example, a solid state storage system. In such cases, analog front end circuit 410, analog to digital converter circuit 415 and equalizer circuit 420 may be eliminated where the data is received as a digital data input.

Equalized output 422 is provided to a user data processing circuit 401 (shown in dashed lines) where it is stored to a sample buffer circuit 475 that includes sufficient memory to maintain one or more codewords until processing of that codeword is completed through a data detector circuit 425 and a data decoder circuit 450 including, where warranted, multiple “global iterations” defined as passes through both data detector circuit 425 and data decoder circuit 450 and/or “local iterations” defined as passes through data decoding circuit 450 during a given global iteration. Sample buffer circuit 475 stores the received data as buffered data 477.

Data detector circuit 425 is a data detector circuit capable of producing a detected output 427 by applying a data detection algorithm to a data input. As some examples, the data detection algorithm may be but is not limited to, a Viterbi algorithm detection algorithm or a maximum a posteriori detection algorithm as are known in the art. Based upon the disclosure provided herein, one of ordinary skill in the art will recognize a variety of data detection algorithms that may be used in relation to different embodiments of the present invention. Data detector circuit 425 may provide both hard decisions and soft decisions. The terms “hard decisions” and “soft decisions” are used in their broadest sense. In particular, “hard decisions” are outputs indicating an expected original input value (e.g., a binary ‘1’ or ‘0’, or a non-binary digital value), and the “soft decisions” indicate a likelihood that corresponding hard decisions are correct. Based upon the disclosure provided herein, one of ordinary skill in the art will recognize a variety of hard decisions and soft decisions that may be used in relation to different embodiments of the present invention.

Detected output 427 is provided to a central queue memory circuit 460 that operates to buffer data passed between data detector circuit 425 and data decoder circuit 450. When data decoder circuit 450 is available, data decoder circuit 450 receives detected output 427 from central queue memory 460 as a decoder input 456. Data decoder circuit 450 applies a data decoding algorithm to decoder input 456 in an attempt to recover originally written data. The result of the data decoding algorithm is provided as a decoded output 454. Similar to detected output 427, decoded output 454 may include both hard decisions and soft decisions. For example, data decoder circuit 450 may be any data decoder circuit known in the art that is capable of applying a decoding algorithm to a received input. Data decoder circuit 450 may be, but is not limited to, a low density parity check decoder circuit or a Reed Solomon decoder circuit as are known in the art. Based upon the disclosure provided herein, one of ordinary skill in the art will recognize a variety of data decoder circuits that may be used in relation to different embodiments of the present invention. Where the original data is recovered (i.e., the data decoding algorithm converges) or a timeout condition occurs, data decoder circuit 450 provides the result of the data decoding algorithm as a data output 474. Data output 474 is provided to a hard decision output circuit 496 where the data is reordered before providing a series of ordered data sets as a data output 498.

One or more iterations through the combination of memory cancelable data detector circuit 425 and data decoder circuit 450 may be made in an effort to converge on the originally written data set. As mentioned above, processing through both the data detector circuit and the data decoder circuit is referred to as a “global iteration”. For the first global iteration, data detector circuit 425 applies the data detection algorithm without guidance from a decoded output. For subsequent global iterations, data detector circuit 425 applies the data detection algorithm to buffered data 477 as guided by decoded output 454. Decoded output 454 is received from central queue memory 460 as a detector input 429.

During each global iteration it is possible for data decoder circuit 450 to make one or more local iterations including application of the data decoding algorithm to decoder input 456. For the first local iteration, data decoder circuit 450 applies the data decoder algorithm without guidance from a decoded output 452. For subsequent local iterations, data decoder circuit 450 applies the data decoding algorithm to decoder input 456 as guided by a previous decoded output 452. In some embodiments of the present invention, a default of ten local iterations is allowed for each global iteration.

To facilitate processing by user data processing circuit 401 of a data stream received as analog input 408, a servo data processing circuit 403 synchronizes to preamble data included in a servo data portion of the data stream received as analog input 408. Servo data processing circuit 403 includes a selector circuit 430 that selects between digital samples 417 and equalized output 422 based upon an X/Y selector input. The selected one of digital samples 417 or equalized output 422 is provided as a servo data input 432. Servo data input 435 includes a preamble portion which is a repeating pattern that may be used for timing synchronization to the received analog input 408, a sector address mark (SAM), a multi-format Gray code, and bust data. The multi-format Gray code includes both high rate codewords and low rate codewords. In one particular embodiment of the present invention, the low rate codewords are encoded such that a ‘111000’ represents a bit value of zero, and a ‘000111’ represents a bit value of one; and high rate codewords are encoded such that a ‘1100’ represents a bit value of zero, and a ‘0011’ represents a bit value of one.

Servo data input 432 is provided to both a servo data framing and format indicator circuit 435 and multi-format servo data detector circuit 440. Servo data framing and format indicator circuit 435 is operable to synchronize the sampling of analog input 408 by analog to digital converter circuit 415 based upon detection of the preamble included in the servo data. This may be done using any preamble detection and synchronization circuitry known in the art. Once servo data framing and format indicator circuit 435 has synchronized to the preamble, it is aware of how many symbols extend from the end of the identified preamble through the SAM and the Gray code data, and whether a given symbol is encoded as part of a high rate codeword or a low rate codeword. Servo data framing and format indicator circuit 435 includes a counter that counts sample periods from the end of the preamble and asserts a symbol indicator 437 and a high/low rate indicator 439 based upon the counter.

In one particular embodiment, symbol indicator 437 is asserted high each time the first bit of a multi-bit symbol is passed as servo data input 432 to multi-format servo data detector circuit 440, and high/low rate indicator 439 is asserted high when the transferring symbol is encoded as part of a high rate codeword and asserted low when the transferring symbol is encoded as part of a low rate codeword. In such an embodiment, multi-format servo data detector circuit 440 applies an extended state data detection to each of the symbols identified by symbol indicator 437 the same way regardless of whether the data is encoded as high rate codewords or low rate codewords. Once the data detection is completed, high/low rate indicator 439 is used to differentiate the high rate encoded codewords from the low rate encoded codewords so they can be decoded to yield the underlying data that is provided as a decoded servo data stream 442.

In one particular case, two bit symbol processing is applied by multi-format servo data detector circuit 440 which is implemented as a four state data detector circuit operable to apply data detection to a series of two bit symbol differentiated in servo data input 432 by symbol indicator 437. Where for example, the received servo data input 432 includes both high rate encoded codewords and low rate encoded codewords where the low rate codewords are encoded such that a ‘111000’ represents a bit value of zero, and a ‘000111’ represents a bit value of one; and high rate codewords are encoded such that a ‘1100’ represents a bit value of zero, and a ‘0011’ represents a bit value of one, a trellis diagram 500 of FIG. 5 shows the legal transitions supported by multi-format servo data detector circuit 440. In particular, the legal transitions (i.e., those transitions that should be expected when processing codewords that are limited to: ‘111000’, ‘000111’, ‘1100’ and ‘0011’), are shown in solid lines, and the illegal transitions (i.e., those transitions that are not expected) are shown in dotted lines. As shown in trellis diagram 500, legal transitions from a prior state 510 to a next state 520 include: a transition 532 from state ‘00’ 512 to state ‘00’ 522, a transition 534 from state ‘00’ 512 to state ‘01’ 524, a transition 536 from state ‘00’ 512 to state ‘11’ 528, a transition 546 from state ‘01’ 514 to state ‘11’ 528, a transition 552 from state ‘10’ 516 to state ‘00’ 522, a transition 562 from state ‘11’ 518 to state ‘00’ 522, a transition 564 from state ‘11’ 518 to state ‘10’ 526, and a transition 566 from state ‘11’ 518 to state ‘11’ 528. The transitions that are not expected are hard pruned (i.e., always pruned) from the trellis and thus not allowed by multi-format servo data detector circuit 440. These disallowed transitions shown in dotted lines include: a transition 542 from state ‘01’ 514 to state ‘00’ 522, a transition 544 from state ‘01’ 514 to state ‘01’ 524, a transition 554 from state ‘10’ 516 to state ‘10’ 526, and a transition 556 from state ‘10’ 516 to state ‘11’ 528.

After applying the detector algorithm represented by trellis diagram 500, multi-format servo data detector circuit 440 has a series of corrected codewords which include a combination of high rate codewords and low rate codewords. Multi-format servo data detector circuit 440 uses high/low rate indicator 439 to differentiate between the high rate codewords and low rate codewords. Where high/low rate indicator 439 indicates a high rate codeword, multi-format servo data detector circuit 440 converts any pattern resulting from application of the data detection algorithm that matches ‘1100’ to a single ‘0’, and any pattern matching ‘0011’ to a single ‘1’. Alternatively, where high/low rate indicator 439 indicates a low rate codeword, multi-format servo data detector circuit 440 converts any pattern resulting from application of the data detection algorithm that matches ‘111000’ to a single ‘0’, and any pattern matching ‘000111’ to a single ‘1’. The resulting series of ‘1s’ and ‘0s’ is provided as decoded servo data stream 442.

In another embodiment, symbol indicator 437 is asserted each time the first bit of a two bit symbol is passed as servo data input 432 to multi-format servo data detector circuit 440, and high/low rate indicator 439 is asserted high when the transferring symbol is encoded as part of a high rate codeword and asserted low when the transferring symbol is encoded as part of a low rate codeword. In such an embodiment, multi-format servo data detector circuit 440 applies an extended state data detection to the received data. As with the preceding embodiment, this extended state data detection applies data detection to two bit symbols, but the trellis diagram is further pruned based upon whether high rate or low rate codewords are being processed, and whether a boundary condition or an internal condition is being processed. Such a boundary condition is a transition between consecutive codewords and the internal condition is a transition between two bit symbols within the same codeword.

In such an embodiment, symbol indicator 437 is a multi-bit indicator with one bit indicating the first bit of a two-bit symbol, and the other bit being asserted high corresponding to an internal condition and asserted low corresponding to a boundary condition. As an example, for a high rate codeword where ‘1100’ corresponds to ‘0’, one bit of symbol indicator 437 is asserted high when the leading ‘1’ of the ‘1100’ codeword is received and when the leading ‘0’ of the ‘1100’ codeword is received to indicate the start of a two bit symbol. In addition, the other bit of symbol indicator is asserted low when the leading ‘1’ of the ‘1100’ codeword is received to indicate a boundary condition and asserted high when the leading ‘0’ of the ‘1100’ codeword is received to indicate an internal condition. As another example, for a low rate codeword where ‘111000’ corresponds to ‘0’, one bit of symbol indicator 437 is asserted high when the leading ‘1’ of the ‘111000’ codeword is received, when the trailing ‘1’ of the ‘111′000’ is received, and when the middle ‘0’ of the ‘111000’ is to indicate the start of each two bit symbol. In addition, the other bit of symbol indicator is asserted low when the leading ‘1’ of the ‘111000’ codeword is received to indicate a boundary condition, and asserted high when the trailing ‘1’ and the middle ‘0’ of the ‘111000’ codeword is received to indicate an internal condition.

As mentioned, by differentiating high and low rate codewords and internal and boundary conditions, the trellis diagram can be selectively pruned to improve the accuracy of the detection applied by multi-format servo data detector circuit. Turning to FIG. 7a, a trellis diagram 601 shows the legal transitions where a boundary condition is indicated by symbol indicator 437 and for either a high rate or a low rate codeword. As shown in trellis diagram 601, the only legal transitions from a prior state 610 to a next state 620 include: a transition 632 from state ‘00’ 612 to state ‘00’ 622, a transition 636 from state ‘00’ 612 to state ‘11’ 628, a transition 662 from state ‘11’ 618 to state ‘00’ 622, and a transition 666 from state ‘11’ 618 to state ‘11’ 628. All other transitions are not expected (including, but not limited to, all transitions to/from states 614, 616, 624, 626), and are thus disallowed whenever a boundary condition is indicated by symbol indicator 437. This conditional disallowance based upon a condition is generally referred to herein as “selective pruning” or is said to be “selectively pruned”.

Turning to FIG. 7b, a trellis diagram 602 shows the legal transitions where an internal condition is indicated for a high rate codeword by symbol indicator 437. As shown in trellis diagram 602, the only legal transitions from prior state 610 to next state 620 include: a transition 676 from state ‘00’ 612 to state ‘11’ 628, and a transition 682 from state ‘11’ 618 to state ‘00’ 622. All other transitions are not expected (including, but not limited to, all transitions to/from states 614, 616, 624, 626), and are thus disallowed whenever an internal condition and a high rate codeword is indicated by symbol indicator 437. Again, by only allowing the limited expected transitions, the accuracy of the data detection process is increased.

Turning to FIG. 7c, a trellis diagram 603 shows the legal transitions where an internal condition is indicated for a low rate codeword by symbol indicator 437. As shown in trellis diagram 603, legal transitions for a first internal condition of a low rate codeword (i.e., a transition from previous state 610 to next state 620) and for a second internal condition of the low rate codeword (i.e., a transition from previous state 620 to a next state 690) are different. For the first internal transition of a low rate codeword, the only legal transitions from prior state 610 to next state 620 include: a transition 672 from state ‘00’ 612 to state ‘01’ 624, and a transition 686 from state ‘11’ 618 to state ‘10’ 626. All other transitions are not expected (including, but not limited to, all transitions to/from states 614, 616, 622, 628), and are thus disallowed whenever a first internal condition and a low rate codeword is indicated by symbol indicator 437. When, on the other hand, the second internal transition of a low rate codeword is processing, the only legal transitions from prior state 620 to next state 690 include: a transition 674 from state ‘00’ 624 to state ‘11’ 698, and a transition 684 from state ‘10’ 626 to state ‘00’ 692. All other transitions are not expected (including, but not limited to, all transitions to/from states 622, 628, 694, 696), and are thus disallowed whenever a first internal condition and a low rate codeword is indicated by symbol indicator 437. Again, by only allowing the limited expected transitions, the accuracy of the data detection process is increased.

In both embodiments, decoded servo data stream 442 is provided to a Gray code error correction circuit 444 and a sector address make detector circuit 448. Sector address mark detector circuit 448 may be any circuit known in the art for detecting a sector address mark from a received data set, and for asserting a SAM found signal 449 when a sector address mark is detected. Gray code error correction circuit 444 may be any circuit known in the art for identifying and utilizing received Gray code data and providing a Gray code indicator 446.

Turning to FIG. 6, a flow diagram 700 shows a method in accordance with some embodiments of the present invention for processing servo data using a four state, symbol based data detector circuit. Following flow diagram 700, an analog input is received (block 705). The analog input may be derived from, for example, a storage medium or a data transmission channel. Where the data is derived from a storage medium, the data includes servo data with portions encoded as high rate codewords and other portions encoded as low rate codewords. Where, on the other hand, the data is derived from a data transmission channel, the data includes synchronization data that includes portions encoded as high rate data and other portions encoded as low rate data. Based upon the disclosure provided herein, one of ordinary skill in the art will recognize a variety of sources of the analog input. The analog input is converted to a series of digital samples (block 710). This conversion may be done using an analog to digital converter circuit or system as are known in the art. Of note, any circuit known in the art that is capable of converting an analog signal into a series of digital values representing the received analog signal may be used. The resulting digital samples are equalized to yield an equalized output (block 715). In some embodiments of the present invention, the equalization is done using a digital finite impulse response circuit as are known in the art. Based upon the disclosure provided herein, one of ordinary skill in the art will recognize a variety of equalizer circuits that may be used in place of such a digital finite impulse response circuit to perform equalization in accordance with different embodiments of the present invention.

One of the equalized output (block 715) or the digital samples (block 710) is selected as servo processing data (block 720). The servo processing data is queried to find a preamble (block 725). Where a preamble is found (block 725), the preamble data is processed and used to adjust timing control (block 730). This may include any preamble processing and/or timing adjustment known in the art. Processing the preamble data is followed by processing sector address mark data at a known position relative to the preamble. Processing the preamble data and/or the sector address mark data results in a framing output and a SAM found signal (block 735). In this embodiment, one bit of the framing output is asserted high each time the first bit of a multi-bit symbol is passed as servo processing data and another bit of the framing output is asserted low to indicate a low rate codeword and high to indicated a high rate codeword. The framing output is generated based upon a sample period count from the preamble or from a SAM found depending upon a particular implementation.

A four state symbol based data detection algorithm is applied to the servo processing data on a symbol basis to recover a detected output corresponding to the Gray code data that is encoded as a combination of high rate and low rate codewords (block 740). Each time a two bit symbol is received as indicated by the framing output, the next stage of the data detection algorithm is performed. In one particular case, the low rate codewords are encoded such that a ‘111000’ represents a single ‘0’, and a ‘000111’ represents a single ‘1’; and high rate codewords are encoded such that a ‘1100’ represents a single ‘0’, and a ‘0011’ represents a single ‘1’. In such a case, the trellis diagram 500 of FIG. 5 shows the legal transitions allowed in the four state symbol based data detection. In particular, the legal transitions (i.e., those transitions that should be expected when processing codewords that are limited to: ‘111000’, ‘000111’, ‘1100’ and ‘0011’), are shown in solid lines, and the illegal transitions (i.e., those transitions that are not expected) are shown in dotted lines. As shown in trellis diagram 500, legal transitions from prior state 510 to next state 520 include: transition 532 from state ‘00’ 512 to state ‘00’ 522, transition 534 from state ‘00’ 512 to state ‘01’ 524, transition 536 from state ‘00’ 512 to state ‘11’ 528, transition 546 from state ‘01’ 514 to state ‘11’ 528, transition 552 from state ‘10’ 516 to state ‘00’ 522, transition 562 from state ‘11’ 518 to state ‘00’ 522, transition 564 from state ‘11’ 518 to state ‘10’ 526, and transition 566 from state ‘11’ 518 to state ‘11’ 528. The transitions that are not expected are hard pruned (i.e., always pruned or disallowed) from the trellis and thus not allowed during application of four state symbol based data detection. These disallowed transitions shown in dotted lines include: transition 542 from state ‘01’ 514 to state ‘00’ 522, transition 544 from state ‘01’ 514 to state ‘01’ 524, transition 554 from state ‘10’ 516 to state ‘10’ 526, and transition 556 from state ‘10’ 516 to state ‘11’ 528.

Once application of the four state data detection algorithm has completed for each codeword, the bit of the framing output indicating either a high rate codeword or a low rate codeword is used to decode the respective codewords (block 745). In particular, where the framing output indicates a high rate codeword, the corresponding codewords in the detected output are decoded by replacing a pattern that matches ‘1100’ by a single ‘0’, and any pattern matching ‘0011’ by a single ‘1’. Alternatively, where the framing output indicates a high rate codeword, the corresponding codewords in the detected output are decoded by replacing a pattern that matches ‘111000’ by a single ‘0’, and any pattern matching ‘000111’ by a single ‘1’. The resulting series of ‘1s’ and ‘0s’ is provided as recovered Gray code data. Burst processing is then applied to burst data following the Gray code data (block 750).

Turning to FIG. 8, a flow diagram 800 showing a method in accordance with some embodiments of the present invention for processing servo data using a selectively pruned four state, symbol based data detection. Following flow diagram 800, an analog input is received (block 805). The analog input may be derived from, for example, a storage medium or a data transmission channel. Where the data is derived from a storage medium, the data includes servo data with portions encoded as high rate codewords and other portions encoded as low rate codewords. Where, on the other hand, the data is derived from a data transmission channel, the data includes synchronization data that includes portions encoded as high rate data and other portions encoded as low rate data. Based upon the disclosure provided herein, one of ordinary skill in the art will recognize a variety of sources of the analog input. The analog input is converted to a series of digital samples (block 810). This conversion may be done using an analog to digital converter circuit or system as are known in the art. Of note, any circuit known in the art that is capable of converting an analog signal into a series of digital values representing the received analog signal may be used. The resulting digital samples are equalized to yield an equalized output (block 815). In some embodiments of the present invention, the equalization is done using a digital finite impulse response circuit as are known in the art. Based upon the disclosure provided herein, one of ordinary skill in the art will recognize a variety of equalizer circuits that may be used in place of such a digital finite impulse response circuit to perform equalization in accordance with different embodiments of the present invention.

One of the equalized output (block 815) or the digital samples (block 810) is selected as servo processing data (block 820). The servo processing data is queried to find a preamble (block 825). Where a preamble is found (block 825), the preamble data is processed and used to adjust timing control (block 830). This may include any preamble processing and/or timing adjustment known in the art. Processing the preamble data is followed by processing sector address mark data at a known position relative to the preamble. Processing the preamble data and/or the sector address mark data results in a framing output and a SAM found signal (block 835). In this embodiment, a first bit of the framing output is asserted high each time the first bit of a multi-bit symbol is passed as servo processing data, a second bit of the framing output is asserted low to indicate a low rate codeword and high to indicated a high rate codeword, and a third bit of the framing output is asserted high to indicate a boundary condition and low to indicate an internal condition is being processed. Such a boundary condition is a transition between consecutive codewords and the internal condition is a transition between two bit symbols within the same codeword.

As an example, for a high rate codeword where ‘1100’ corresponds to ‘0’, the first bit of framing output is asserted high when the leading ‘1’ of the ‘1100’ codeword is received and when the leading ‘0’ of the ‘1100’ codeword is received to indicate the start of a two bit symbol. In addition, the second bit of the framing output is asserted low when the leading ‘1’ of the ‘1100’ codeword is received to indicate a boundary condition and asserted high when the leading ‘0’ of the ‘1100’ codeword is received to indicate an internal condition; and the third bit of the framing output is asserted to indicate a high rate codeword. As another example, for a low rate codeword where ‘111000’ corresponds to ‘0’, a first bit of the framing output is asserted high when the leading ‘1’ of the ‘111000’ codeword is received, when the trailing ‘1’ of the ‘111′000’ is received, and when the middle ‘0’ of the ‘111000’ is to indicate the start of each two bit symbol. In addition, the second bit of the framing output is asserted low when the leading ‘1’ of the ‘111000’ codeword is received to indicate a boundary condition, and asserted high when the trailing ‘1’ and the middle ‘0’ of the ‘111000’ codeword is received to indicate an internal condition. The third bit of the framing output is asserted to indicate a low rate codeword. The framing output is generated based upon a sample period count from the preamble or from a SAM found depending upon a particular implementation.

Based upon the second and third bits of the framing output, it is determined whether the next symbol being received (as indicated by the first bit of the framing output) if it is: a high rate codeword and a boundary condition (block 840), a high rate codeword and an internal condition (block 850), a low rate codeword and a boundary condition (block 860), or a low rate codeword and an internal condition (block 870). Where the next symbol being received is a high rate codeword and a boundary condition (block 840) or a low rate codeword and a boundary condition (block 860), the trellis operation of a four state data detector circuit applying a four state, symbol based data detection algorithm is pruned to match the boundary condition (block 845). Turning to FIG. 7a, trellis diagram 601 shows the legal transitions where a boundary condition is indicated by the framing output and for either a high rate or a low rate codeword. As shown in trellis diagram 601, the only legal transitions from prior state 610 to next state 620 include: transition 632 from state ‘00’ 612 to state ‘00’ 622, transition 636 from state ‘00’ 612 to state ‘11’ 628, transition 662 from state ‘11’ 618 to state ‘00’ 622, and a transition 666 from state ‘11’ 618 to state ‘11’ 628. All other transitions are not expected (including, but not limited to, all transitions to/from states 614, 616, 624, 626), and are thus disallowed whenever a boundary condition is indicated by the framing output. This conditional disallowance based upon a condition is generally referred to herein as “selective pruning” or is said to be “selectively pruned”.

Alternatively, where the next symbol being received is a high rate codeword and an internal condition (block 850), the trellis operation of a four state data detector circuit applying a four state, symbol based data detection algorithm is pruned to match the high rate codeword and internal condition (block 855). Turning to FIG. 7b, trellis diagram 602 shows the legal transitions where an internal condition is indicated for a high rate codeword by the framing output. As shown in trellis diagram 602, the only legal transitions from prior state 610 to next state 620 include: transition 676 from state ‘00’ 612 to state ‘11’ 628, and transition 682 from state ‘11’ 618 to state ‘00’ 622. All other transitions are not expected (including, but not limited to, all transitions to/from states 614, 616, 624, 626), and are thus disallowed whenever an internal condition and a high rate codeword is indicated by the framing output. Again, by only allowing the limited expected transitions, the accuracy of the data detection process is increased.

Alternatively, where the next symbol being received is a low rate codeword and an internal condition (block 870), the trellis operation of a four state data detector circuit applying a four state, symbol based data detection algorithm is pruned to match the low rate codeword and internal condition (block 875). Turning to FIG. 7c, trellis diagram 603 shows the legal transitions where an internal condition is indicated for a low rate codeword by the framing output. As shown in trellis diagram 603, legal transitions for a first internal condition of a low rate codeword (i.e., a transition from previous state 610 to next state 620) and for a second internal condition of the low rate codeword (i.e., a transition from previous state 620 to next state 690) are different. For the first internal transition of a low rate codeword, the only legal transitions from prior state 610 to next state 620 include: transition 672 from state ‘00’ 612 to state ‘01’ 624, and transition 686 from state ‘11’ 618 to state ‘10’ 626. All other transitions are not expected (including, but not limited to, all transitions to/from states 614, 616, 622, 628), and are thus disallowed whenever a first internal condition and a low rate codeword is indicated by the framing output. When, on the other hand, the second internal transition of a low rate codeword is processing, the only legal transitions from prior state 620 to next state 690 include: transition 674 from state ‘00’ 624 to state ‘11’ 698, and transition 684 from state ‘10’ 626 to state ‘00’ 692. All other transitions are not expected (including, but not limited to, all transitions to/from states 622, 628, 694, 696), and are thus disallowed whenever a first internal condition and a low rate codeword is indicated by the framing output. Again, by only allowing the limited expected transitions, the accuracy of the data detection process is increased.

After the selective pruning is complete (blocks 840, 845, 850, 855, 870, 875) for the next symbol, the next stage of the four state, symbol based data detection is applied using pruned possible transitions to recover a detected output (block 880). This process continues until the four state, symbol based data detection is applied to all of the Gray code data. Once the end of the Gray code data is identified (block 885), the bit of the framing output indicating either a high rate codeword or a low rate codeword is used to decode the respective codewords (block 890). In particular, where the framing output indicates a high rate codeword, the corresponding codewords in the detected output are decoded by replacing a pattern that matches ‘1100’ by a single ‘0’, and any pattern matching ‘0011’ by a single ‘1’. Alternatively, where the framing output indicates a high rate codeword, the corresponding codewords in the detected output are decoded by replacing a pattern that matches ‘111000’ by a single ‘0’, and any pattern matching ‘000111’ by a single ‘1’. The resulting series of ‘1s’ and ‘0s’ is provided as recovered Gray code data. Burst processing is then applied to burst data following the Gray code data (block 895).

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for out of order data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing system, the data processing system comprising:
a multi-format data processing circuit operable to process a data set including at least a first codeword encoded using a first encoding format and a second codeword encoded using a second encoding format, and wherein the multi-format data processing circuit includes:
a data detection circuit operable to apply a symbol based data detection algorithm to symbols derived from the data set, wherein each symbol represents less than the number of bits in the first codeword and the number of bits in the second codeword.

2. The data processing system of claim 1, wherein the first codeword is a low rate codeword, and wherein the second codeword is a high rate codeword.

3. The data processing system of claim 1, wherein each symbol is a two bit symbol, wherein the first codeword is six bits, wherein the second codeword is four bits, wherein the first encoding format represents one bit value with six data bits, and wherein the second encoding format represents one bit value with four bits.

4. The data processing system of claim 3, wherein the first encoding format represents a ‘1’ as ‘000111’, and a ‘0’ as ‘11100’, and wherein the second encoding format represents a ‘1’ as ‘0011’, and a ‘0’ as ‘1100’.

5. The data processing system of claim 1, wherein the symbol based data detection algorithm is implemented to limit possible transitions to those expected when processing symbols derived from the combination of the first encoding format and the second encoding format.

6. The data processing system of claim 1, wherein the symbol based data detection algorithm is selectively pruned to limit possible transitions to those expected when processing symbols derived from the combination of the first encoding format and the second encoding format.

7. The data processing system of claim 6, wherein selectively pruning the symbol based data detection algorithm includes limiting possible transitions based at least in part upon whether a currently processing symbol corresponds to a transition between a boundary of two different codewords.

8. The data processing system of claim 6, wherein selectively pruning the symbol based data detection algorithm includes limiting possible transitions based at least in part upon whether a currently processing symbol corresponds to a transition between two symbols within the same codeword.

9. The data processing system of claim 8, wherein selectively pruning the symbol based data detection algorithm further includes limiting possible transitions based at least in part upon whether a currently processing symbol is derived from the first codeword or the second codeword.

10. The data processing system of claim 1, wherein the data detection circuit is a first data detection circuit, wherein the data set is servo data derived from a storage medium, and wherein the data processing system further comprises:
a second data detection circuit operable to apply a data detection algorithm to a user data set derived from the same source as the servo data set to yield a detected output; and
a data decoder circuit operable to apply a data decoding algorithm to a decoder input derived from the detected output to yield a decoded output.

11. The data processing system of claim 10, wherein the data decoder circuit is a low density parity check decoder circuit.

12. The data processing system of claim 10, wherein the second data detection circuit is selected from a group consisting of: a maximum a posteriori data detector circuit, and a Viterbi algorithm data detector circuit.

13. The data processing system of claim 1, wherein the system is implemented as an integrated circuit.

14. A method for data processing, the method comprising:
receiving a data input including at least a first codeword encoded using a first encoding format and a second codeword encoded using a second encoding format, wherein a length of the first codeword is different from a length of the second codeword; and
applying a symbol based data detection algorithm to symbols derived from the data set, wherein each symbol represents less than the number of bits in the first codeword and the number of bits in the second codeword.

15. The method of claim 14, wherein each symbol is a two bit symbol, wherein the first codeword is six bits, wherein the second codeword is four bits, wherein the first encoding format represents one bit value with six data bits, and wherein the second encoding format represents one bit value with four bits.

16. The method of claim 14, wherein the symbol based data detection algorithm limits possible transitions to those expected when processing symbols derived from the combination of the first encoding format and the second encoding format.

17. The method of claim 14, wherein the symbol based data detection algorithm is selectively pruned to limit possible transitions to those expected when processing symbols derived from the combination of the first encoding format and the second encoding format.

18. The method of claim 17, wherein selectively pruning the symbol based data detection algorithm includes limiting possible transitions based at least in part upon whether a currently processing symbol corresponds to a transition between a boundary of two different codewords.

19. The method of claim 17, wherein selectively pruning the symbol based data detection algorithm includes limiting possible transitions based at least in part upon whether a currently processing symbol corresponds to a transition between two symbols within the same codeword.

20. The method of claim 19, wherein selectively pruning the symbol based data detection algorithm further includes limiting possible transitions based at least in part upon whether a currently processing symbol is derived from the first codeword or the second codeword.

21. A storage device, the storage device comprising:
a storage medium;
a head assembly disposed in relation to the storage medium and operable to provide a sensed signal corresponding to a data set on the storage;
a read channel circuit including:
an analog front end circuit operable to provide an analog signal corresponding to the sensed signal, wherein the sensed signal includes at least a first codeword encoded using a first encoding format and a second codeword encoded using a second encoding format;
an analog to digital converter circuit operable to sample the analog signal to yield a series of digital samples;
a multi-format data processing circuit operable to process a data set derived from the digital samples, wherein the multi-format data processing circuit includes:
a data detection circuit operable to apply a symbol based data detection algorithm to symbols derived from the data set, wherein each symbol represents less than the number of bits in the first codeword and the number of bits in the second codeword.
